(19) United States
(12) Patent Application Publication
(10) Pub. No.: US 2018/0292006 A1
(43) Pub. Date: Oct. 11, 2018

(54) BIMETALLIC PISTON PIN

(71) Applicant: GM GLOBAL TECHNOLOGY OPERATIONS LLC, DETROIT, MI (US)

(72) Inventors: Huaxin Li, Rochester Hills, MI (US); Glenn E. Clever, Washington, MI (US); Daniel J. Wilson, Linden, MI (US)

(73) Assignee: GM GLOBAL TECHNOLOGY OPERATIONS LLC, Detroit, MI (US)

(21) Appl. No.: 15/482,845

(22) Filed: Apr. 10, 2017

(51) Int. Cl. F16J 1/16

(52) U.S. Cl. CPC F16J 1/16

(57) ABSTRACT

A bimetallic piston pin for a vehicle engine includes a tubular steel alloy shell, a first core member, a second core member and a middle core member. The tubular steel alloy shell includes a first end, a second end and a middle region. The tubular steel alloy shell also includes an interior surface and an exterior surface. The first core member may be disposed within the tubular steel alloy shell at the first end and the second core member may also disposed within the tubular steel alloy shell at the second end. The middle core member may be disposed within the tubular steel alloy shell between the first core member and the second core member.

### TECHNICAL FIELD

This present disclosure relates generally to a vehicle engine, and more particularly to a piston pin for a vehicle engine.

### BACKGROUND

Reciprocating internal combustion engines generally use pistons that oscillate in the cylinder. The piston functions as a sliding plug that fits closely inside the bore of a cylinder. Essentially, the piston is driven alternately in the cylinder. The burning of a mixture of fuel and aft above a piston generates gas pressure from compressed and ignited combustion gases. This pressure forces the piston in a downward direction. As this happens, the piston transmits the force of expanding combustion gases through the piston pin to the connecting rod. The piston is attached to the connecting rod, and thus to the crankshaft, transferring reciprocating motion to rotating motion.

Piston pins form an important part of the reciprocating internal combustion engine system. Each piston pin extends through aligned openings in the piston and the connecting rod, to establish a pivotal connection between the rod and the piston. As the engine crankshaft rotates, one end of each connecting rod orbits around the crankshaft axis. The other end of the connecting rod has swivel motion around the pin within the piston, whereby each piston delivers power through the connecting rod to the crankshaft. Each piston pin serves as a pivotal connection between the connecting rod and piston.

The forces imposed on the piston, piston pin and connecting rod from combustion are enormous. In addition, piston assemblies (pistons, piston pins and the connecting rods discussed above) account for a large amount of the friction losses in an engine's performance, There is a trend in engine design to reduce the reciprocating mass of the piston assembly including the crankshaft. Thus performance can be enhanced by having a lighter piston pin, which reduces inertial losses, thereby improving engine efficiency. Accordingly, being lightweight is an essential characteristic of an effective piston pin and piston assembly. In addition, the ideal piston pin possesses other important characteristics: wear resistance, rigidity and high strength for withstanding the extreme forces that result from the combustion process. One method of reducing the weight of the piston pin is to reduce the mass at the ends of the internal diameters of the pin by creating an outwardly tapered internal portion.

Certain piston pins are formed with a center solid cross section near the middle of the otherwise hollow pin. These piston pins are referred to as center webbed, two way extruded or two way formed piston pins wherein the piston pin is generally formed from the same material throughout. Other piston pins carry weight reduction even further by having a solid cross section on the end of the pin.

Accordingly, it would be desirable in the industry to provide a lightweight, yet durable piston pin which may withstand the significant loads imposed in the reciprocating internal combustion engine system.

### SUMMARY

Accordingly, the present disclosure provides a bimetallic piston pin for a vehicle engine which includes a tubular steel alloy shell, a first core member, a second core member and a middle core member. The bimetallic piston pin may withstand significant sheer loads as well as bending loads at a reduced weight/thickness for the steel alloy shell thereby reducing mass in counterweights associated with a piston assembly. The tubular steel alloy shell of the bimetallic piston pin includes a first end, a second end and a middle region. The tubular steel alloy shell also includes an interior surface and an exterior surface. The first core member may be disposed within the tubular steel alloy shell at the first end and the second core member may also disposed within the tubular steel alloy shell at the second end. The middle core member may be disposed with the tubular steel alloy shell between the first core member and the second core member.

The present disclosure also provides for a piston assembly for a vehicle engine. The piston assembly includes a piston, a connecting rod and a bimetallic piston pin. The piston may be operatively configured to move between a first position and a second position (back and forth) in a combustion chamber. The connecting rod may be coupled to the piston via a bimetallic piston pin. The bimetallic piston pin includes a tubular steel alloy shell, a first core member, a second core member and a middle, core member. The tubular steel alloy shell includes a first end, a second end and a middle region, the tubular steel alloy shell having an interior surface and an exterior surface. The first core member may be disposed within the tubular steel alloy shell. The second core member may be disposed within the tubular steel alloy shell. The middle core member disposed with the tubular steel alloy shell between the first core member and the second core member. The core members are configured to support the tubular steel ahoy shell as bending forces are applied to the pin due to loads applied from the connecting rod and piston. The tubular steel alloy shell may be induction hardened so as to withstand shear loads applied to the bimetallic piston pin.

It is understood that the first, second, and middle core members may be formed via a casting process from a lightweight metal such as but not limited to magnesium, aluminum, and titanium. Each of the first, second and middle core members may define a plurality of apertures. The plurality of apertures in each of the first, second and middle core members may include a center aperture and may also include a plurality of radial apertures which surround the center aperture.

The first core member may be being disposed proximate to the first end of the tubular steel alloy shell. The second core member may be disposed proximate to the second end of the tubular steel alloy shell. The middle core member may be disposed proximate to the middle region of the tubular steel alloy shell.

Each of the first, second and middle core members may be joined to the inner surface of the tubular steel alloy shell at a circumferential surface of each of the first, second and middle core members via induction hardening the steel alloy shell and simultaneously brazing a zinc coating at the circumferential surface of each of the first, second and middle core members at the inner surface of the tubular steel alloy shell. The zinc coating may melt via the induction hardening process thereby brazing the first, second and middle core members to the interior surface of the tubular steel alloy shell.

It is understood that each of the first and second embodiments of the present disclosure may further include a fourth core member and a fifth core member. The fourth core member may be disposed between the first and middle core members within the tubular steel alloy shell. The fifth core member may be disposed between the middle and second core members within the tubular steel alloy shell. Regardless of the number of core members included within the tubular steel alloy shell, plurality of core members may be even distributed along the longitudinal axis of the tubular steel alloy shell.

It is understood that the first, second, middle, fourth and fifth core members are simultaneously joined to the interior surface of the tubular steel alloy shell via the induction hardening of the steel alloy shell and brazing of tubular steel alloy shell to the first, second, middle, fourth and fifth core members.

The present disclosure and its particular features and advantages will become more apparent from the following detailed description considered with reference to the accompanying drawings.

### BRIEF DESCRIPTION OF THE DRAWINGS

These and other features and advantages of the present disclosure will be apparent from the following detailed description of preferred embodiments, and best mode, appended claims, and accompanying drawings in which:

FIG. 1 is a perspective view of an example piston assembly having a piston coupled to a connecting rod via a bimetallic piston pin in accordance with the present disclosure.

FIG. 2 is an enlarged view of an embodiment of the bimetallic piston pin of the present disclosure.

FIG. 3 is a schematic side view of an example core for use in a bimetallic piston pin in accordance with the present disclosure.

FIG. 4 is a top schematic view of the bimetallic piston pin in accordance with various embodiments of the present disclosure.

FIG. 5 illustrates a flow chart for the process to manufacture a core for a bimetallic piston pin in accordance to various embodiments of the present disclosure.

FIG. 6 is a flow chart which illustrates the manufacturing process for the assembly of a bimetallic piston pin in accordance with the present disclosure.

Like reference numerals refer to like parts throughout the description of several views of the drawings.

### DETAILED DESCRIPTION

Reference will now be made in detail to presently preferred compositions, embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

Except in the examples, or where otherwise expressly indicated, all numerical quantities in this description indicating amounts of material or conditions of reaction and/or use are to be understood as modified by the word “about” in describing the broadest scope of the present disclosure. Practice within the numerical limits stated is generally preferred. Also, unless expressly stated to the contrary: percent, “parts of,” and ratio values are by weight; the description of a group or class of materials as suitable or preferred for a given purpose in connection with the present disclosure implies that mixtures of any two or more of the members of the group or class are equally suitable or preferred; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The terms “comprising”, “consisting of”, and “consisting essentially of” can be alternatively used. Where one of these three terms is used, the presently disclosed and claimed subject matter can include the use of either of the other two terms.

Throughout this application, where publications are referenced, the disclosures of these publications in their entireties are hereby incorporated by reference into this application to more fully describe the state of the art to which this present disclosure pertains.

The following detailed description is merely exemplary in nature and is not intended to limit the present disclosure or the application and uses of the present disclosure. Furthermore, there is no intention to be bound by any theory presented in the preceding background or the following detailed description.

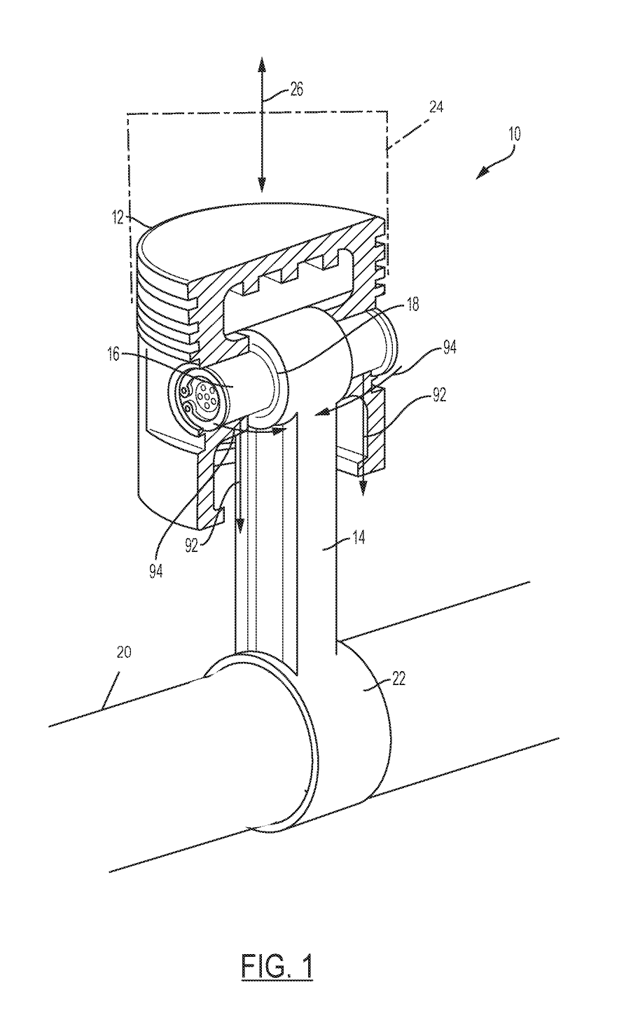

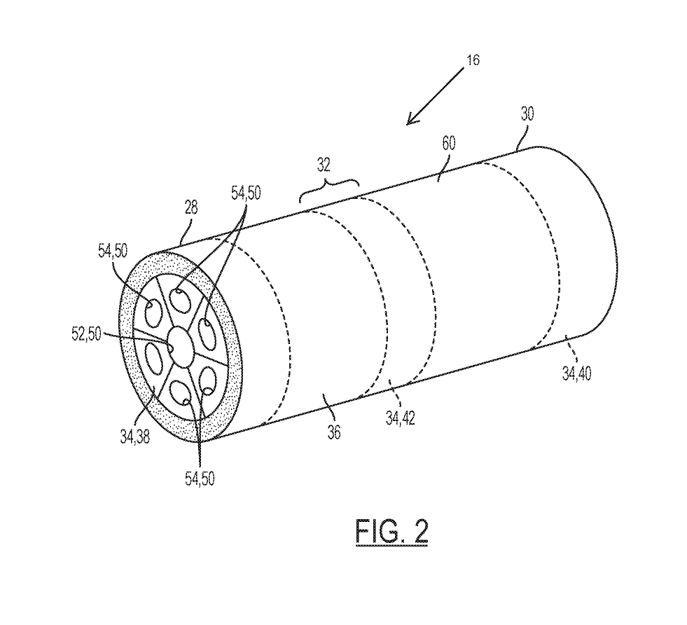

With reference to FIG, 1, a perspective view of an example piston assembly 10 is shown. The piston assembly 10 includes a piston 12 connected to a connecting rod 14 via a bimetallic piston pin 16 is shown, It is understood that the connecting rod 14 is coupled to the piston 12 at a proximate end 18 while the connecting rod 14 is coupled to a shaft 20 at a distal end 22—which is opposite the proximate end 18. As the shaft 20 of the engine rotates, the connecting rod 14 moves back and forth relative to its associated combustion chamber 24 thereby moving the piston 12 relative to the axis 26 of the combustion chamber 24. The bimetallic piston pin 16 includes a particularly lightweight yet durable design as shown in FIGS. 2-4. The bimetallic piston pin 16 of the present disclosure may withstand significant sheer loads 92 (shown in FIG. 1) as well as bending loads 94 (shown in FIG. 1) at a reduced weight/thickness 66 for the steel alloy shell 35 of the piston pin 16 thereby reducing mass in counterweights associated with a piston assembly 10.

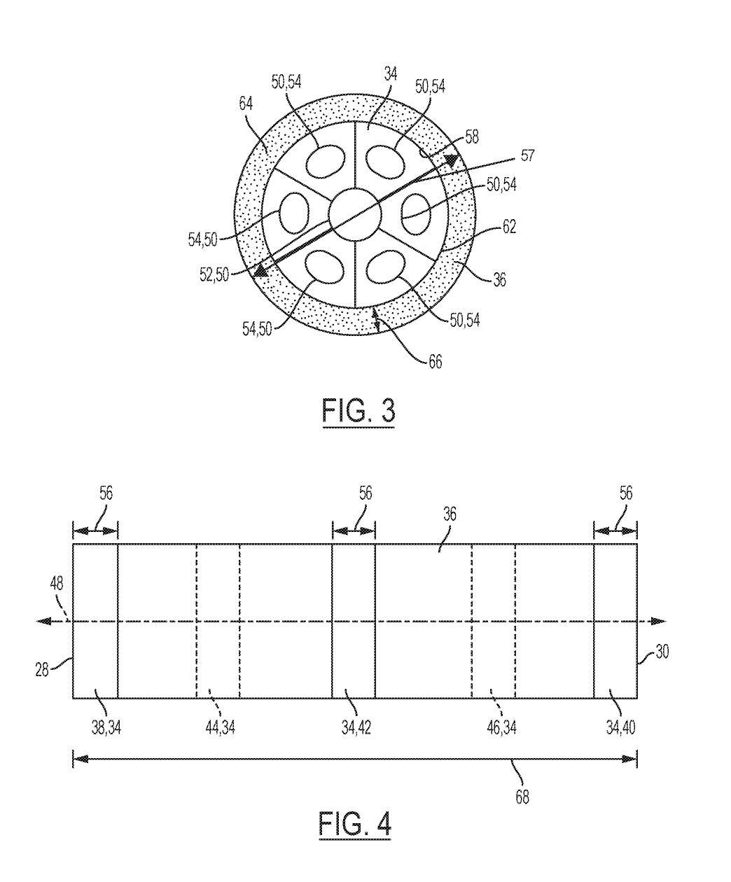

Accordingly, the piston assembly 10 of FIG. 1 includes a piston 12, a connecting rod 14, and a bimetallic piston pin 16. The piston 12 may be operatively configured to move back and forth in a combustion chamber 24. The connecting rod 14 may be coupled to the piston 12 via the bimetallic piston pin 16. The bimetallic piston pin 16 further includes a tubular steel alloy shell 36, a first core member 38, a second core member 40 and a middle core member 42. The tubular steel alloy shell 36 includes a first end 28, a second end 30 and a middle region 32. The tubular steel alloy shell 36 also defines an interior surface 58 and an exterior surface 60 (see FIGS. 2 and 3). The first core member 38 may be disposed within the tubular steel alloy shell 36 at the first end 28 of the piston pin 16. The second core member 40 may be disposed within the tubular steel ahoy shell at the second end 30 of the piston pin 16. The middle core member 42 may be disposed with the tubular steel alloy shell 36 between the first core member 38 and the second core member 40. The core members 38, 40, 42 are configured to support the tubular steel alloy shell 36 as bending forces 94 (FIG. 1) are applied to the pin 16 due to loads 92 applied from the connecting rod and piston. The tubular steel alloy shell 36 may be induction hardened so as to withstand shear loads 92 applied to the bimetallic piston pin 16. The piston pin 16 has a reduced weight via the tubular steel alloy shell 36 having a reduced thickness 66 (shown in FIG. 3) in conjunction with the core members 38, 40, 42.

FIG. 2 is an enlarged isometric view of the bimetallic piston pin 16 from FIG. 1. As indicated, the bimetallic piston pin 16 includes a first end 28, a second end 30, and a middle region 32. A plurality of core members 34 (as shown in the example of FIG. 3) may be disposed inside of a steel shell 36 wherein a first core member 38 may be disposed proximate to the first end 28, a second core member 40 may be disposed proximate to the second end 30, and a middle core member 42 disposed inside the steel shell 36 in the middle region 32 of the hollow steel shell 36. It is understood that additional core members 34 may be added such that the core members 34 are substantially evenly distributed along the axis 27 of the steel alloy shell 36 as shown in FIG. 4.

It is understood that a fourth core member 44 and a fifth core member 46 may optionally be disposed within the tubular steel alloy shell 36. The fourth core member 44 may be disposed between the first and middle core members 38, 42 within the tubular steel alloy shell 36. The fifth core member 46 may be disposed between the middle and second core members 42, 40 within the tubular steel alloy shell 36 as shown in FIG. 4. Regardless of the number of core members included within the tubular steel alloy shell, plurality of core members 34 may be even distributed along the longitudinal axis 27 of the tubular steel ahoy shell 36.

It is understood that the first, second, middle, (and optionally fourth and fifth 44, 46 if added) core members 38, 40, 42 may be simultaneously joined to the interior surface 58 of the tubular steel alloy shell vie the induction hardening of the steel alloy shell 36 and brazing of tubular steel alloy shell 36 to the first, second, middle, fourth and fifth core members 38, 40, 42, 44, 46.

With reference to FIG. 3, a schematic side view of the bimetallic piston pin 16 having a core member 34 disposed within the steel alloy shell 36 is shown. With further reference to FIG. 4, the bimetallic piston pin 16 for a vehicle, engine has core members 34 which may be defined as a first core member 38, a second core member 40 and a middle, core member 42. The tubular steel alloy shell 36 includes a first end 28, a second end 30 and a middle region 32. The tubular steel alloy shell 36 also includes an interior surface 58 and an exterior surface 60 (shown in FIGS. 2 and 3). As indicated, the first core member 38 may be disposed within the tubular steel alloy shell 36 at the first end 28 and the second core member 40 may also disposed within the tubular steel alloy shell 36 at the second end 30 (shown in FIG. 4). The middle core member 42 may be disposed with the tubular steel alloy shell 36 between the first core member 38 and the second core member 40.

As shown, a core member 34 may define a plurality of apertures 50. The plurality of apertures 50 may but not necessarily include a center aperture 52 with multiple radial apertures 54 defined around the center apertures 52. While FIG. 3 illustrates six radial apertures 54 are shown around the center aperture 52, there may be as little as two radial apertures 54, or more than six radial apertures 54. Moreover, it is understood that a center aperture 52 in a core member 34 may or may not be implemented as part of the plurality of apertures 50. The plurality of apertures 50 may have varying sizes and shapes. Moreover, the core member 34 thickness 56 (shown in FIG. 4) may fall within a range of about 3 mm to about 5 mm while the steel alloys shell 36 thickness 66 may fall within a range of about 2 mm to about 4 mm. It is understood that the overall length 68 of the steel alloy shell 36 may fall within a range of about 30 mm to about 80 mm, and the overall outer diameter range 57 may fall within the range of about 15 mm to 25 mm. Noting that the thickness 66 of the steel alloy shell 36 may fall within the range of about 2 mm to 4 mm, the bimetallic piston pin 16 of the present disclosure provides for an improved mass/weight reduction.

Each core member 34 may be formed from any one or more lightweight materials such as but not limited to titanium, aluminum, magnesium, etc. The core member 34 may also be formed via a precision casting method or the like due to the intricate configuration of the core member 34. It is further understood that the core member 34 may be affixed to the inner surface 60 of the steel shell 36 at its circumferential surface 62 via an induction hardening of the steel shell 36 which simultaneously brazes the inner surface 60 of the steel shell 36 to the circumferential surface 62 of the core member 34. A zinc coating or filler material (shown schematically as 64 in FIG. 3) is applied over the entire circumferential surface 62 of core member 34 such that zinc coating 64 is disposed either on the circumferential outer surface 62 of core member 34 or the inner surface 58 of the shell 36 or both surface. The zinc coating 64 melts when the induction hardening process of the steel shell 36 occurs thereby brazing the core members 34 to the steel shell 36. The melted brazed filler material 64 (ex: zinc coating) is used to join the core members to the tubular steel alloy shell when the brazed filler material 64 solidifies. It is understood that the brazed filler material (shown as element 64 in FIG. 3) may alternatively be formed from at least one of an aluminum alloy, a copper alloy, and a nickel ahoy.

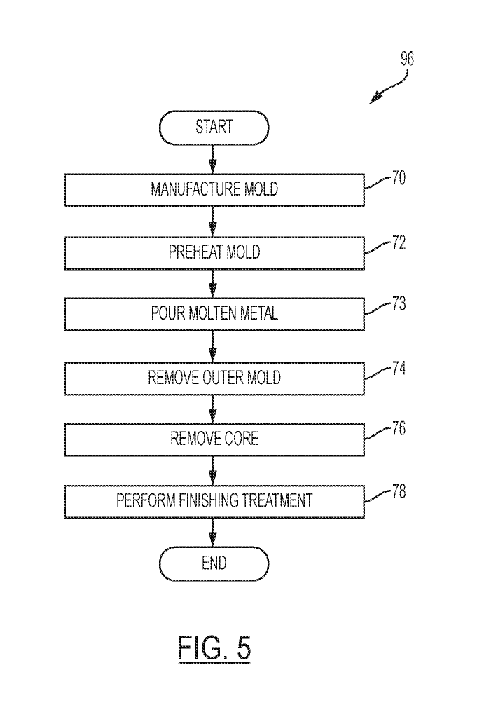

The casting method for the core member 34 will now be described with reference to the flow chart 96 of FIG. 5. In the casting method, in the first step 70, a mold for the core member 34 is initially manufactured via wax material, ceramic material, and a die in accordance to a traditional precision casting method. The wax material may then be repeatedly coated with a ceramic material to form the mold as part of the first step 70. In the second step 72, the mold and any associated internal structures (ex: rods) may be preheated after the mold is manufactured in step 70. The internal structures (ex: rods) may be used to create the apertures 50 shown in core member 34. For example, in the heating process, the mold and associated internal structures may be placed in a furnace (a vacuum furnace and a combustion furnace) and may be heated in the range of 800° C.-900° C. Due to the preheat treatment, it is possible to suppress the breakage of the mold when molten metal (melted metal) is injected into the mold to manufacture cast metal.

In the third step 73 for manufacturing the core member 34, molten metal is poured into the mold with internal structures after the mold and structures are preheated. As indicated earner, the core member 34 may be formed from a lightweight material such as titanium, magnesium, aluminum or the like and therefore, the molten metal may be formed from aluminum, magnesium, titanium, or the like. Molten metal may be a raw material of melted cast metal which may be injected into the opening of the mold. The molten metal then solidifies inside of the mold (and solidify around any associated internal structures) as the molten metal cools. In the fourth step 74 for manufacturing the core member 34, the mold may then be removed by breaking away pieces of the mold which surround the core member 34 and in the fifth step 76, the associated internal structures may be removed (“pulled out”) of the solidified material. As indicated, the internal structures, such as but not limited to rods, are configured to define any apertures 50 in the core member 34 (solidified material). In the sixth step 78, the solidified material in the form of the core member 34 may be milled so as to remove any unnecessary structure which was formed by feeding molten metal into the mold and to smooth any rough surfaces of the core member 34. In the casting method above, the removal process for any internal structures (ex: rods) may be performed after the mold is removed from the solidified material. It is understood that in the process illustrated in FIG. 5, the finishing treatment step 78 may be performed after the core removal process is performed. That is, a finishing treatment may be performed on the surface or the inside of the cast metal (solidified material)—such as edge regions of apertures 50. Further, in the casting method, the quality of the cast metal may be checked along with the finishing treatment.

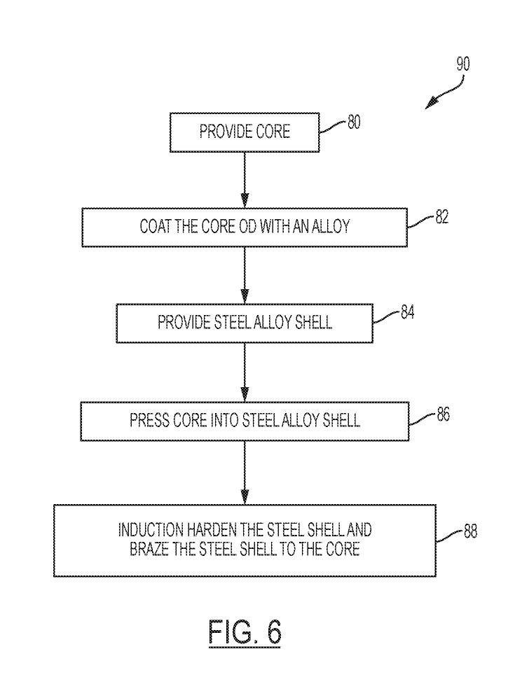

Referring now to FIG. 6, a flowchart 90 is shown which illustrates an example, non-limiting manufacturing process to assemble the core member 34 to the steel ahoy shell 36. In the first step 80, the core members may be provided from the process shown in FIG. 5. In the second step 82 of FIG. 6, the circumferential surface 62 of each core member 34 may be coated with an alloy such as but not limited to a zinc coating via a plating or hot dipping process. Other alloys which may be used could be an aluminum alloy, copper alloy and/or a nickel alloy, In the third step 84 of FIG. 6, a steel alloy shell 36 is provided. In the fourth step 86, the core member 34 is pressed into the steel alloy shell 36 via a mechanical/hydraulic press. In the fifth step 88 of FIG. 6, the steel shell 36 may be induction hardened while simultaneously brazing the steel shell 36 to the core. In this step 88, the zinc coating 64 is melted from the heat produced by the induction hardening process such that the core members are effectively brazed to the interior surface 58 of the steel alloy shell 36 at the circumferential surface 62 of each core member.

The resulting structure from the assembly process in FIG. 6 is a bimetallic piston pin 16 which can withstand sheer loads 92 as well as bending loads 94 as the connecting rod 14 and piston 12 reciprocate, in a back and forth movement. The induction hardening of the steel shell 36 strengthens the steel shell 36 against the sheer loads 92 applied to the bimetallic piston pin 16 while the core members 34 strengthen the bimetallic piston pin 16 as bending loads 94 are applied to the bimetallic piston pin 16.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A bimetallic piston pin for a vehicle engine comprising:
a tubular steel alloy shell having a first end, a second end and a middle region, the tubular steel alloy shell having an interior surface and an exterior surface;
a first core member disposed within the tubular steel alloy shell;
a second core member disposed within the tubular steel alloy shell;
a middle core member disposed with the tubular steel alloy shell between the first core member and the second core member; and
a brazed filler material disposed between the interior surface of the tubular steel alloy shell and each of the first, second, and middle core member.

2. The bimetallic piston pin of claim 1 wherein each of the first, second, and middle core members are formed via a casting process from a lightweight metal.

3. The bimetallic piston pin of claim 2 wherein each of the first, second and middle core members define a plurality of apertures.

4. The bimetallic piston pin of claim 3 wherein the brazed filler material being formed from at least one of zinc alloy, aluminum alloy, copper alloy and nickel alloy.

5. The bimetallic piston pin of claim 4 wherein the plurality of apertures in each of the first, second, and middle core members includes a center aperture and a plurality of radial apertures which surround the center aperture.

6. The bimetallic piston pin of claim 5 wherein the first core member being disposed proximate to the first end of the tubular steel alloy shell, the second core member being disposed proximate to the second end of the tubular steel alloy shell, and the middle core member being disposed proximate to the middle region of the tubular steel alloy shell.

7. The bimetallic piston pin of claim 6 wherein each of the first, second and middle core members are joined to the inner surface of the tubular steel alloy shell at a circumferential surface of each of the first, second and middle core members via induction hardening the steel alloy shell and simultaneous brazing of the circumferential surface of each of the first, second and middle core members at the inner surface of the tubular steel alloy shell.

8. The bimetallic piston pin of claim 7 further comprising a fourth core member disposed between the first and middle core members within the tubular steel alloy shell and a fifth core member disposed between the middle and second core members within the tubular steel alloy shell.

9. The bimetallic piston pin of claim 8 wherein the first, second, middle, fourth and fifth core members are simultaneously joined to the interior surface of the tubular steel alloy shell via the induction hardening of the steel alloy shell and brazing of tubular steel alloy shell to the first, second, middle, fourth and fifth core members.

10. The bimetallic piston pin of claim 9 wherein a zinc coating is disposed between the interior surface of the tubular steel alloy shell and the circumferential surface of each of the first, second, middle, fourth and fifth core members.

11. The bimetallic piston pin of claim 10 wherein the zinc coating is melted when the tubular steel alloy shell is subject to induction hardening, and the zinc coating is operatively configured to join at least 50% of the circumferential surface of each of the first, second, middle, fourth and fifth core members to the interior surface of the tubular steel alloy shell.

12. A piston assembly for a vehicle engine comprising:
a piston operatively configured to move between back and forth in a combustion chamber;
a connecting rod coupled to the piston via a bimetallic piston pin, the bimetallic piston pin further comprising
a tubular steel alloy shell having a first end, a second end and a middle region, the tubular steel alloy shell having an interior surface and an exterior surface;
a first core member disposed within the tubular steel alloy shell;
a second core member disposed within the tubular steel alloy shell;
a middle core member disposed with the tubular steel alloy shell between the first core member and the second core member; and
a brazed filler material disposed between the interior surface of the tubular steel alloy shell and each of the first, second and middle core members.

13. The piston assembly of claim 12 wherein each of the first, second, and middle core members are formed via a casting process from a lightweight metal.

14. The piston assembly of claim 13 wherein each of the first, second and middle core members define a plurality of apertures.

15. The piston assembly of claim 14 wherein the plurality of apertures in each of the first, second and middle core members includes a center aperture.

16. The piston assembly of claim 15 wherein the plurality of apertures in each of the first, second, and middle core members includes a plurality of radial apertures which surround the center aperture.

17. The piston assembly of claim 16 wherein the first core member being disposed proximate to the first end of the tubular steel alloy shell, the second core member being disposed proximate to the second end of the tubular steel alloy shell, and the middle core member being disposed proximate to the middle region of the tubular steel alloy shell.

18. The piston assembly of claim 17 wherein each of the first, second and middle core members are joined to the inner surface of the tubular steel alloy shell at a circumferential surface of each of the first, second and middle core members via induction hardening the steel alloy shell and simultaneous brazing of the circumferential surface of each of the first, second and middle core members at the inner surface of the tubular steel alloy shell.

19. The piston assembly of claim 18 further comprising a fourth core member disposed between the first and middle core members within the tubular steel alloy shell and a fifth core member disposed between the middle and second core members within the tubular steel alloy shell.

20. The piston assembly of claim 19 wherein the first, second, middle, fourth and fifth core members are simultaneously joined to the interior surface of the tubular steel alloy shell via the induction hardening of the steel alloy shell and brazing of tubular steel alloy shell to the first, second, middle, fourth and fifth core members.
